(19) United States
(12) Patent Application Publication
(10) Pub. No.: US 2011/0139898 A1
(43) Pub. Date: Jun. 16, 2011

(54) FOLDABLE ROLLER BASE FOR A SPRINKLER

(76) Inventor: PAO-YUN SHIH, Changhua County (TW)

(21) Appl. No.: 12/637,754

(22) Filed: Dec. 15, 2009

(51) Int. Cl. B05B 15/06

(52) U.S. Cl. 239/280.5

(57) ABSTRACT

A foldable roller base for a sprinkler of the present invention has a roller base body having at least two assembly portions extending away from each other; each assembly portion has a cylinder with a plurality of limiting stops on a bottom edge; and at least two roller base arms coupled to the assembly portions of the roller base body, one end of each roller base arm having a pivoting portion, and the other end having a roller. The roller base arms utilize one end of the pivoting portions for coupling to the cylinders of the assembly portions, and the cylinders have a plurality of limiting stops on their bottom edges. Therefore, the roller base arms are capable of being rotated around the cylinder for different purposes.

### BACKGROUND OF THE INVENTION

1. Field of the Invention

The present invention relates to a foldable roller base for a sprinkler, and more particularly to a roller base that can be folded in different ways to provide a reduced size for storage of the base structure.

2. Description of the Related Art

Currently, a prior art roller base, as shown in FIG. 9, has a roller base 40 with a rigid body, which has two roller base arms 41, and each roller base arm 41 forms a predetermined angle with the roller base 40 and has a roller 411 at its free end. The roller base 40 further includes a first opening 42 and a second opening 43 at its front and rear ends; a water conduit connects between the first opening 42 and the second opening 43, and a water dispensing opening 44 on the top surface of the roller base 40 is connected to the water conduit. When a sprinkler is installed onto the water dispensing opening 44, the rollers 411 can move the roller base 40 to different areas for water sprinkling, and a hose is connected to the first opening to supply water.

However, the prior art roller base has following drawbacks:

The roller base 40 is a rigid member, including the roller base arms 41 and the rollers 411, which has a large size and thus requires for a significant amount of space for storage.

Therefore, it is desirable to provide a foldable roller base for a sprinkler to mitigate and/or obviate the aforementioned problems.

### SUMMARY OF THE INVENTION

An objective of the present invention is to provide a foldable roller base for a sprinkler, which can be folded in different ways to provide a reduced size for storage of the base structure

In order to achieve the above-mentioned objective, the foldable roller base for a sprinkler of the present invention has a roller base body having at least two assembly portions extending away from each other; each assembly portion has a cylinder with a plurality of limiting stops on a bottom edge; and at least two roller base arms coupled to the assembly portions of the roller base body, one end of each roller base arm having a pivoting portion, and the other end having a roller. The roller base arms utilize one end of the pivoting portions for coupling to the cylinders of the assembly portions, and the cylinders have a plurality of limiting stops on their bottom edges. Therefore, the roller base arms are capable of being rotated around the cylinder for different purposes.

With the above-mentioned structure, the following benefit can be obtained: the roller base of the present invention has two roller base arms along both sides of the roller base body, each of which has a roller and are able to be rotated around the assembly portion. Therefore, the roller base can be folded in different ways to provide a reduced size for storage.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is an exploded view of an embodiment of the present invention.

FIG. 3 is a schematic drawing of an embodiment of the present invention.

FIG. 4 is a local detailed view of an embodiment of the present invention.

FIG. 5 shows a cylinder and a pivoting portion being engaged together in cross section.

FIG. 6 is a schematic drawing of utilizing an embodiment of the present invention.

FIG. 7 is a schematic drawing of an embodiment of the present invention being opened.

FIG. 8 is a schematic drawing of an embodiment of the present invention being closed.

FIG. 9 is a perspective view of a prior art structure.

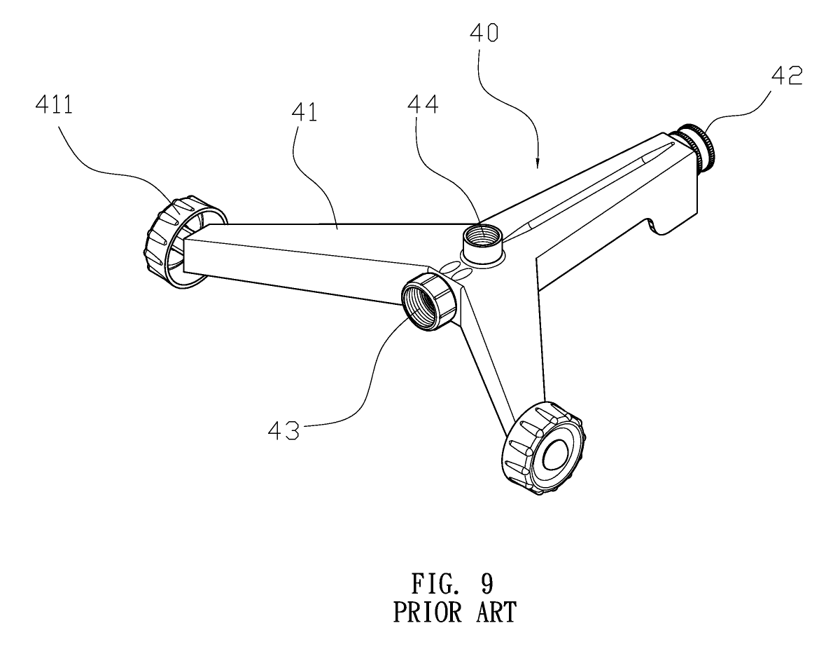

### DETAILED DESCRIPTION OF THE PREFERRED EMBODIMENT

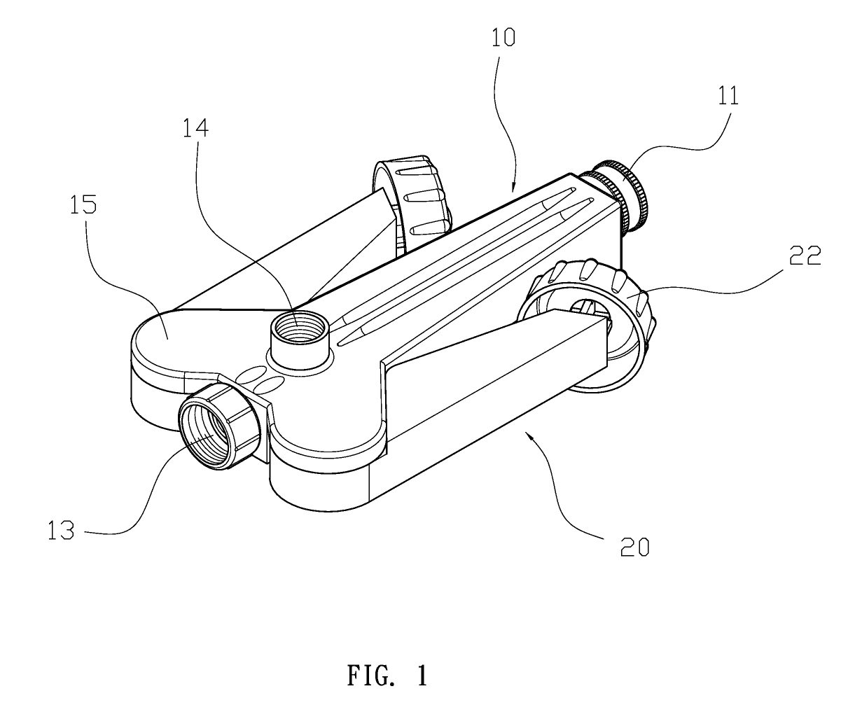

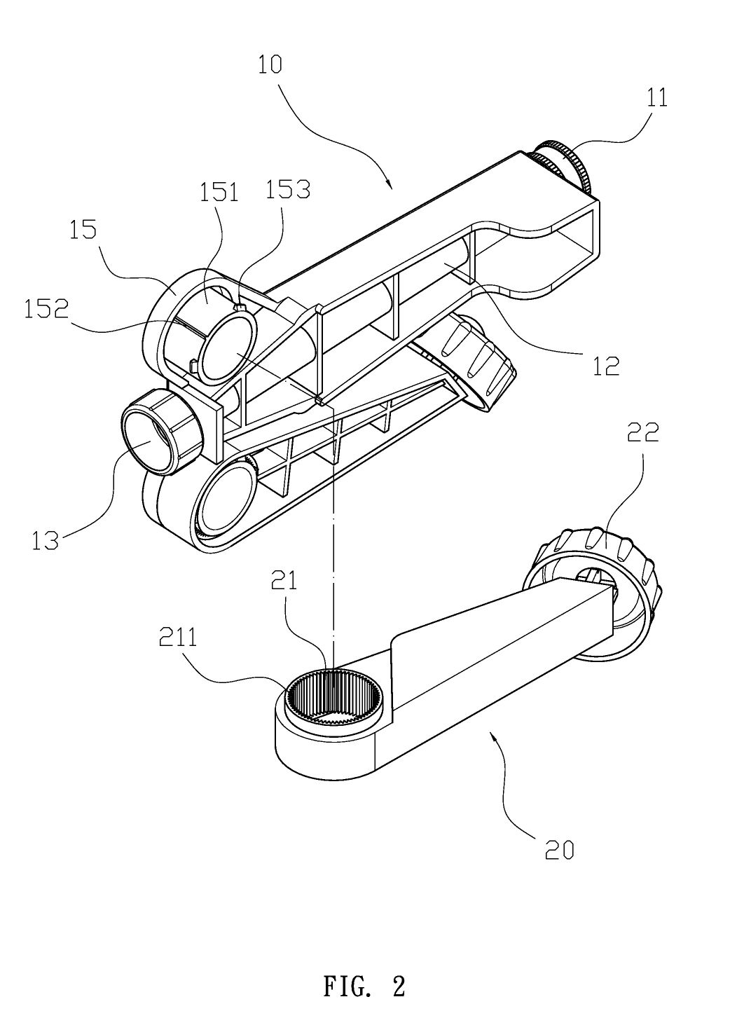

Please refer to FIG. 1 and FIG. 2. A foldable roller base for a sprinkler comprises a roller base body 10 and two roller base arms 20. One end of the roller base body 10 has a first opening 11, and the first opening 11 extends through the roller base body 10 to form a water conduit 12. The water conduit 12 extends to another end of the roller base body 10 and connects to a second opening 13. The top surface of the roller base body 10 has a water dispensing opening 14 connected to the water conduit 12, and the water dispensing opening 14 further includes a pivoted protrusion with threads. The roller base body 10 has two assembly portions 15 extending away from each other, and each assembly portion 15 has a cylinder 151. The cylinder 151 has a positioning rib 152 at its outer side and a plurality of limiting stops 153 on a bottom edge. The two roller base arms 20 are coupled to the assembly portions 15 of the roller base body 10. Additionally, one end of each roller base arm 20 has a pivoting portion 21 and teeth 211 at the inner side of the pivoting portion 21, while the other end of the roller base arm 20 has a roller 22.

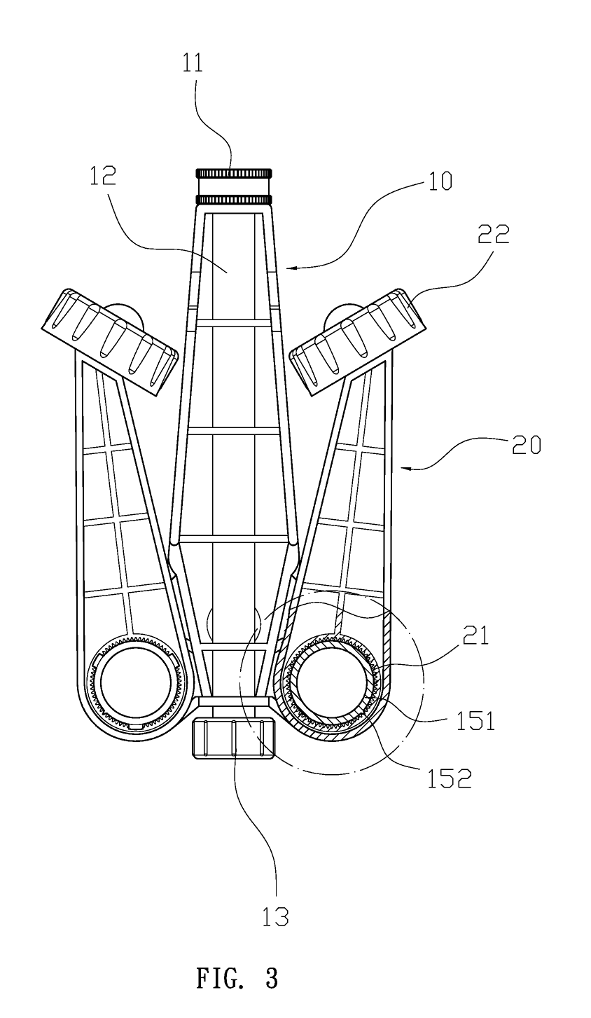

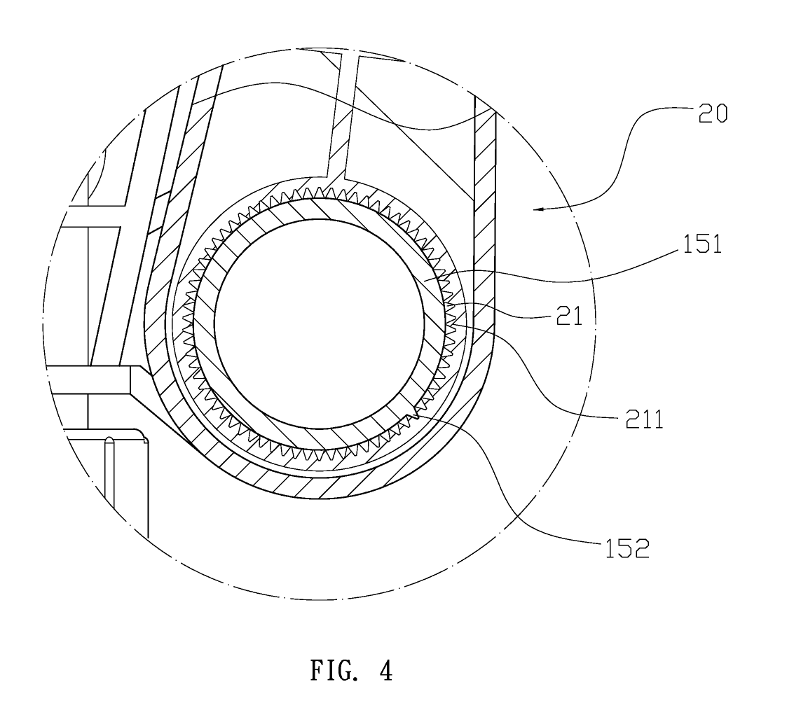

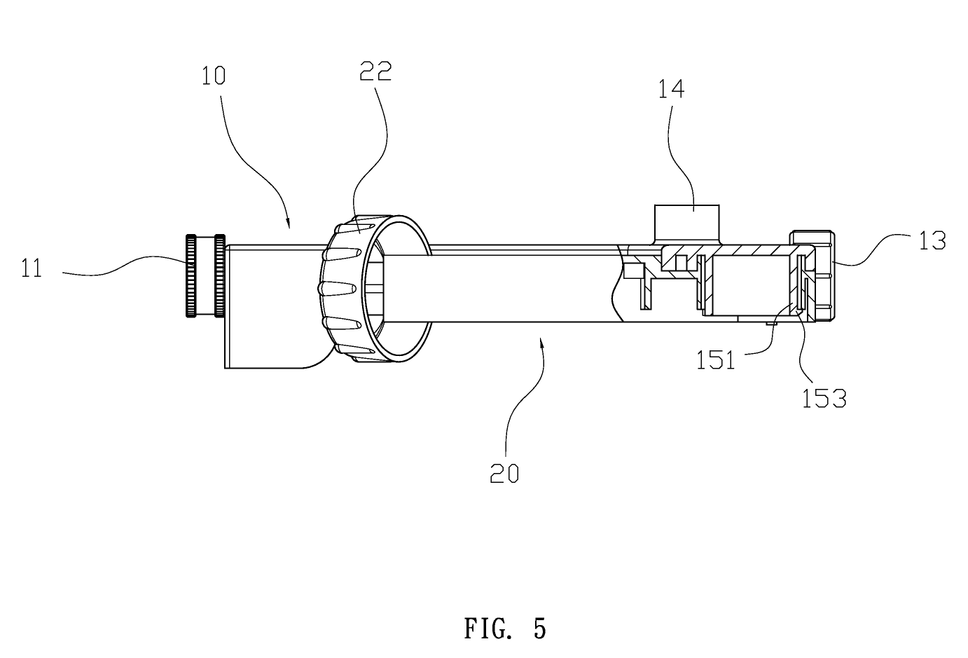

For an assembly of an embodiment of the present invention, please refer to FIG. 2 to FIG. 5. The roller base arms 20 are respectively coupled to the assembly portions 15 of the roller base body 10, and the roller base arms 20 utilize one end of the pivoting portions 21 for coupling to the cylinders 151 of the assembly portions 15. The cylinders 151 have a plurality of limiting stops 153 on their bottom edges, and the roller base arms 20 are secured to the assembly portions 15 of the roller base body 10 by the limiting stops 153. The positioning ribs 152 are disposed on the side walls of the cylinders 151 and correspond to the teeth 211 disposed inside of the pivoting portions 21; therefore, each roller base arm 20 is not only able to rotate around the cylinder 151 but may also be positioned by the engagement between the teeth 211 and the positioning rib 152.

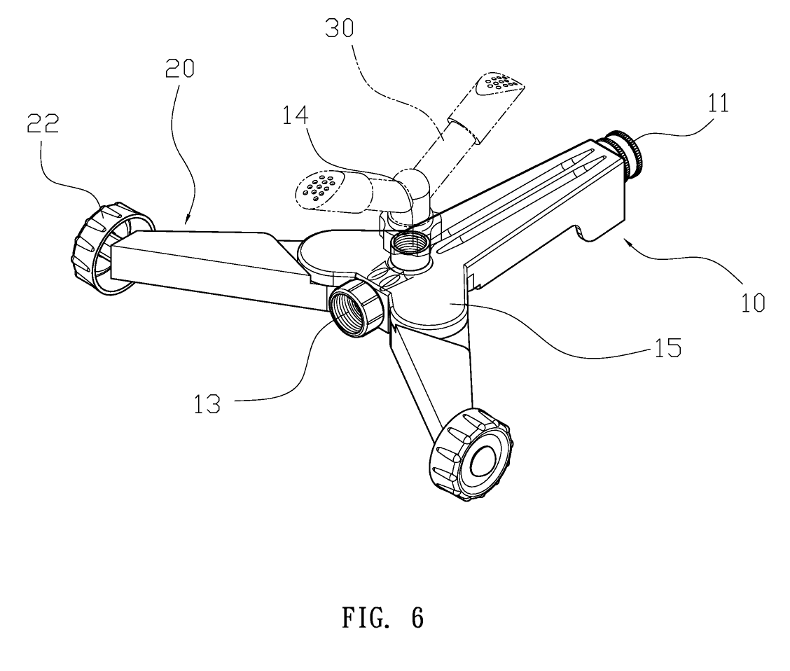

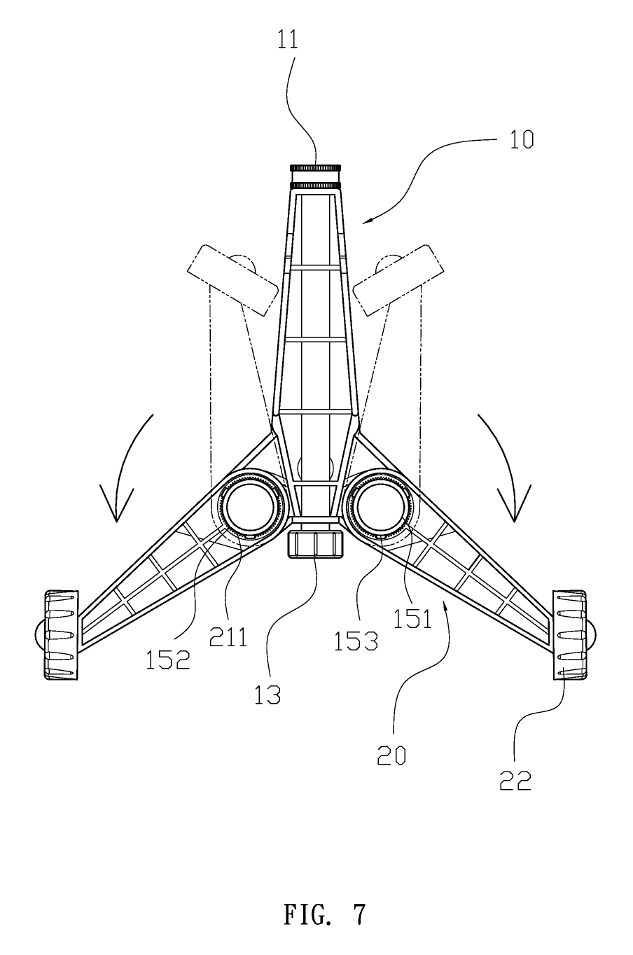

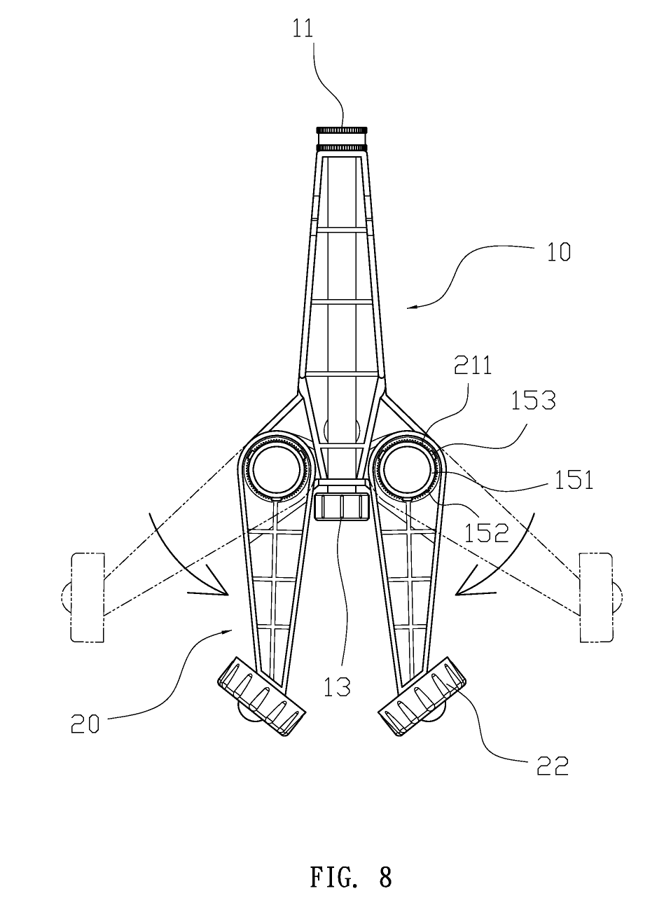

For operations, please refer to FIGS. 6, 7 and 8. The first opening 11 at the end of the roller base body 10 is adapted for connection to a hose and a water outlet for supplying water, and the second opening 13 at the other end can be connected to another hose and another roller base body 10. Accordingly, water can run through the water conduits 12, and the water dispensing opening 14 on the top of the roller base body 10 is adapted for connection to a sprinkler 30. The roller base arms 20 installed onto the assembly portion 15 of the roller base body 10 can be folded in or opened up. In order to use the foldable roller base, the roller base arms 20 at each side of the roller base body 10 are opened up so a predetermined angle is formed between each roller base arm 20 and the roller base body 10. The engagement between the teeth 211 and the positioning ribs 152 causes the rollers 22 at the other end of each of two roller base arms 20 to be parallel to each other, such that the roller base body 10 is capable of being moved by the rollers 22. When the foldable roller base needs to be stored away, the roller base arms 20 at the each side of the roller base body 10 are folded in to be adjacent to the roller base body 10, thereby providing a reduced size for storage. Alternatively, the roller base arms 20 can also be pushed more open to be aligned with the roller base body 10, which also provides a reduced size for storage purposes.

With the above-mentioned structure, the following benefit can be obtained: the roller base of the present invention has two roller base arms 20 along both sides of the roller base body 10, each of which has a roller 22 and are able to be rotated around the assembly portion 15. Therefore, the roller base can be folded in different ways to provide a reduced size for storage.

Although the present invention has been explained in relation to its preferred embodiment, it is to be understood that many other possible modifications and variations can be made without departing from the spirit and scope of the invention as hereinafter claimed.

What is claimed is:

1. A foldable roller base for a sprinkler comprising:
a roller base body having at least two assembly portions extending away from each other, each assembly portion having a cylinder with a plurality of limiting stops on a bottom edge; and
at least two roller base arms coupled to the assembly portions of the roller base body, one end of each roller base arm having a pivoting portion, and the other end having a roller.

2. The foldable roller base for a sprinkler as claimed in claim 1, wherein one end of the roller base body has a first opening, the first opening extending through the roller base body to form a water conduit, the water conduit extending to another end of the roller base body and connected to a second opening; wherein a top surface of the roller base body has a water dispensing opening connected to the water conduit, and the water dispensing opening further comprises a rotatable protrusion with threads.

3. The foldable roller base for a sprinkler as claimed in claim 1, wherein an outer side of each cylinder comprises a positioning rib.

4. The foldable roller base for a sprinkler as claimed in claim 1, wherein an inner side of the pivoting portion of each roller base arm comprises teeth.
